(19) United States
(12) Patent Application Publication
(10) Pub. No.: US 2010/0319727 A1
(43) Pub. Date: Dec. 23, 2010

(54) INDUSTRIAL PLATE CLEANER

(76) Inventor: Charles J. Schmidt, Diboll, TX (US)

Correspondence Address: FULBRIGHT & JAWORSKI, LLP, 1301 MCKINNEY, SUITE 5100, HOUSTON, TX, 77010-3095, US

(21) Appl. No.: 12/490,165

(22) Filed: Jun. 23, 2009

(51) Int. Cl. B08B 7/00; B24B 7/00; B24B 1/00

(52) U.S. Cl. 134/6; 451/64; 451/28

(57) ABSTRACT

An apparatus for insertion between parallel press plates and cleaning the press plates is disclosed. The cleaning apparatus comprises an abrasive assembly and a linear motor. The abrasive assembly is attached to a first movable member of the linear motor and/or a second movable member of a linear motor. The linear motor is operated using an air pressure supply. As the cleaning apparatus is moved between the parallel press plates, unwanted residue is removed from the parallel press plates.

### TECHNICAL FIELD

The present invention is generally related to an industrial platen cleaner for cleaning the surface of at least one platen which is spaced parallel to a second platen. In particular, the present invention provides an apparatus that is useful for cleaning, smoothing and/or polishing parallel platens used in the manufacturing of engineered wood products.

### BACKGROUND OF THE INVENTION

The present invention is generally related to cleaning the platens used in producing engineered wood products. Engineered wood, also called composite wood, “man made wood” or “manufactured wood”, includes a range of derivative wood products which are manufactured by binding together the strands, particles, fibers, or veneers of wood, together with adhesives, to form composite materials. These products are engineered to precise design specifications which are tested to meet national or international standards.

Typically, engineered wood products are made from the same hardwoods and softwoods used to manufacture lumber. Sawmill scraps and other wood waste can be used for engineered wood composed of wood particles or fibers, but whole logs are usually used for veneers, such as plywood. Alternatively, it is also possible to manufacture similar engineered cellulosic products from other lignin-containing materials such as rye straw, wheat straw, rice straw, hemp stalks, kenaf stalks, or sugar cane residue, in which case they contain no actual wood but rather vegetable fibers.

Engineered wood products are used in a variety of ways, often in applications similar to solid wood products. Engineered wood products may be preferred over solid wood in some applications due to certain comparative advantages: (1) because engineered wood is man-made, it can be designed to meet application-specific performance requirements; (2) large panels of engineered wood may be manufactured from fibres from small diameter trees; (3) small pieces of wood, and wood that has defects, can be used in many engineered wood products, especially particle and fiber-based boards; and (4) engineered wood products are often stronger and less prone to humidity-induced warping than equivalent solid woods. Although most particle and fiber-based boards readily soak up water unless they are treated with sealant or paint.

Examples of engineered wood products include I-joist, glued laminated timber, multilaminar veneer, veneer-based, plywood, laminated veneer lumber (LVL), parallel strand lumber (PSL), stamina wood, parallam, parallel strand lumber, particle-based, oriented strand board (OSB), laminated strand lumber (LSL), waferboard, particleboard (chipboard), fiberboard, insulation board, medium-density fiberboard (MDF), hardboard, mineral-bonded particleboard and fiberboard, cement board, fiber cement siding, gypsum board, papercrete, strawboard, and wood-plastic composite.

For example, oriented strand board (OSB) is an engineered, mat-formed panel product made of strands, flakes or wafers sliced from small diameter, round wood logs and bonded with an exterior-type binder under heat and pressure. Oriented strand board panels consist of layered mats. Exterior or surface layers are composed of strands aligned in the long panel direction; inner-layers consist of cross-aligned strands or randomly-aligned strands. These large mats are then subjected to intense heat and pressure to become a “master” panel and are cut to size. Strand dimensions are predetermined and have a uniform thickness.

The strength of oriented strand board comes mainly from the uninterrupted wood fiber, interweaving of the long strands or wafers, and degree of orientation of strands in the surface layers. Waterproof and boil proof resin binders are combined with the strands to provide internal strength, rigidity and moisture resistance. In general, the types of resins or adhesives used in engineered wood include: urea-formaldehyde resins, phenol-formaldehyde resins, melamine-formaldehyde resin, methylene diphenyl diisocyanate (MDI) or polyurethane resins.

Most press platens are heated and therefore cook resin onto the platen surfaces causing a buildup that damages the product being pressed by the platen and slows the transfer of heat from the platen to the product. This resin build up on the platen is non-uniform and may be up to an eighth of an inch thick. Use of the platens having this build up causes indentations in the platens and retards heat trasfer from the platens to the wood product. The indentations in the platens lead to defects in the wood product. Heat transfer is imporatant because heat is needed to melt the resin/adhesive for binding the board. This heat transfer must be uniform and quick. If the heat transfer is not quick, the cycle time will be slower and wood product produced will be uneven. Therefore, it is beneficial to regenerate a smooth and polished platen surface to ensure that the engineering wood product is not defective.

In general, the platens are periodically cleaned by hand, using rotary cleaners and/or a press scraper. Each method has its disadvantages. For example, it is certainly not practical to clean by hand a series of pairs of press platen surfaces that are 75 feet long and 54 inches wide with 30-50 openings between each pair of platens of five to six inches. The rotary cleaner requires disassembly of the entire press. The press scrapers remove the heavy resin buildup which leaves small occlusions that compromise the quaility of the wood product. In some cases, the press platen may be damaged by a foreign object such as a nut or bolt. In these cases, cleaning by hand, using a rotary cleaner or using a press scraper will be less effective in restoring a smooth and polished platen surface.

There is a great need for a light-weight, fast device for cleaning, smoothing and polishing the sufaces of press platens and other surfaces. Specifically, there is a need for an apparatus that can clean, smooth and polish parallel plates, is hand-held or may be easily handled by one or two people, is small enough to fit in an opening of five to six inches tall by four and a half feet wide, and may be operated over distances exceeding 75 feet.

### BRIEF SUMMARY OF THE INVENTION

The present invention is directed to a system and method for removing unwanted residue from parallel press platens. In general, the apparatus for cleaning the surface of a press platen is made of a linear motor configured to be capable of moving at least one movable member of the apparatus between at least two positions, and at least one abrasive assembly connected to the movable member. In some embodiments, the apparatus has a first movable member and a second movable member connected to a linear motor housing and the linear motor housing is configured to be capable of moving the first movable member and the second movable member simultaneously.

In some alternate and additional embodiments, the linear motor housing causes the first movable member to move in a parallel and opposite direction to the simultaneous movement of the second movable member. In some examples, at least one abrasive assembly is secured to the first movable member or at least one abrasive assembly is secured to the second movable member. In some cases, the at least one abrasive assembly is secured to both the first and second movable members. The linear motor is a two cycle linear air motor powered by an air supply.

In specific embodiments, the apparatus is adapted to fit between two generally parallel platen surfaces such that the abrasive assembly is contacting a first press platen surface with sufficient pressure to reduce a thickness of a resin layer adhered to the first press platen surface. IN some embodiments, the apparatus is used to remove substantially all of the resin layer from the press platen surface. In other additional embodiments, the apparatus is used to create a substantially uniform press platen surface. In particular embodiments, the abrasive assembly may be any one of the following examples of an abrasive media. These examples include, but are not limited to sand paper, scraper blades, file segments, scouring pad, a brush and any combination thereof.

In certain embodiments, the two cycle linear air motor is made of a motor housing with at least a first and a second chamber. Each chamber has at least one opening and the openings of consecutive chambers are positioned approximately 180 degrees from each other. The linear air motor contains a first movable member and a second movable member. The first movable member has a platform and at least one first perpendicular member. The first perpendicular member of the first movable member is received by the first chamber of the motor housing. The second movable member has a platform and at least one second perpendicular member. The second perpendicular member is received by the second chamber of the motor housing. The linear air motor has at least one set of first inflatable elements. The set of first inflatable elements contains two individual first inflatable elements. One first inflatable element is positioned in the first chamber and the other inflatable element is positioned in the second chamber. The linear air motor has at least one set of second inflatable elements. The set of second inflatable elements has two individual second inflatable elements. One second inflatable element is positioned in the first chamber and the other inflatable element is positioned in the second chamber. In the linear air motor, the first chamber has a first perpendicular member situated between the first inflatable element and the second inflatable element and the second chamber has a second perpendicular member situated between the first inflatable element and a second inflatable element. The air supply is connected to the first set of inflatable elements and connected to the second set of inflatable elements.

In some embodiments, the air supply provides air pressure to the first set of inflatable elements and the second set of inflatable elements in an alternating cycle. In specific examples, the air pressure provided by the air supply is between 30 psi to 600 psi.

In certain embodiments the present disclosure provides, a method for cleaning at least a first press platen spaced parallel to a second press platen with the following steps: placing a cleaning apparatus between the first press platen and the second press platen, initializing the linear motor, moving the cleaning apparatus along a longitudinal path between the first press platen and second press platen, and removing residue from at least the first press platen. In some cases, the cleaning apparatus comprises at least one abrasive assembly and a linear motor.

In some embodiments, the method for cleaning parallel press platens includes the step of removing indentations from at least the first press platen. In some additional and alternate embodiments, the method includes the step of polishing at least the first press platen. In additional embodiments, the method includes the step of smoothing at least the first press platen.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1A shows an expanded view of the linear air motor;

FIG. 1B shows a side view of a two-cycle linear air motor during the first cycle of motion;

FIG. 1C shows a side view of a two-cycle linear air motor during the second cycle of motion;

FIG. 2 shows a rear view of an industrial platen cleaner and provides an example of how two or more industrial platen cleaners may be used together;

FIG. 3 shows a side view of the linear motor wherein inflatable members 302, 303, 306 and 307 are inflated;

FIG. 4 show a side view of the linear motor wherein the inflatable members 402, 403, 406 and 407 are inflated;

FIG. 5 shows a side view of the linear motor wherein inflatable members 501, 504, 505 and 508 are inflated;

FIG. 6 shows a side view of the linear motor wherein inflatable members 601, 604, 605 and 608 are inflated;

FIG. 7 shows the inflatable members connected to the linear air motor header;

FIG. 8 is a rear view of a industrial platen cleaner and provides an example of how two or more industrial platen cleaners may be powered by one air supply; and,

FIG. 9 shows a perspective view of the linear air motor.

### DETAILED DESCRIPTION OF THE INVENTION

The present invention is generally related to an industrial platen cleaner for cleaning the surface of at least one press platen which is spaced parallel to a second press platen. In particular, the present industrial cleaner is useful for inserting between first and second spaced and parallel engineered wood product press platens and for cleaning the platens. Additionally, the industrial cleaner may be moved between the parallel press platens using any means available to the skilled artisan. For example, the industrial cleaner may be pulled using a rope, a cable, a winch and/or any combination or equivalent thereof. In another example, the industrial cleaner may be moved using hydraulic and/or pneumatic pressure. In yet another example, the existing belt system of the press may be used to move the industrial cleaner. As a final example, an extension rod or stick may be used to push or pull the industrial cleaner.

In one general embodiment, the present invention comprises an air supply, a linear motor powered by the air supply, and an abrasive assembly linearly moved by the linear motor. The abrasive assembly may be connected to one or both sides of the linear motor. The abrasive assembly is further comprised of an abrasive media for cleaning, smoothing and/or polishing a flat surface. In general, a suitable abrasive media may be any material that can remove unwanted residue from a surface. A suitable abrasive media may include, but is not limited to sand paper, scraper blades, file segments, scouring pad, a brush, a polishing cloth and/or any combination thereof. For example, the abrasive media may be a squilgee for removing excess water during the cleaning process.

In general, the linear motor of this embodiment is comprised of five major components: a first movable member, a second movable member, a motor housing, a linear air motor header and an inflatable member. The first movable member and the second movable member are located on opposite sides of the motor housing. The two movable members are designed to move in parallel and opposite directions. The inflatable member is made of an air tight material that can support between 20 and 600 psi of air pressure and is at least a half inch in diameter. Examples of the inflatable member may include, but are not limited to a water hose, a garden hose, a fire hose, rubber tubing, plastic tubing, a bladder, polymer tubing and/or any functional equivalents thereof. Each inflatable member is connected to the air supply through the linear air motor header. The air supply can be any source that supplies between 20 and 600 psi of pressure and enough volume to fill at least one inflatable member.

In some cases, it may be advantageous to use two or more industrial cleaners in tandem. One industrial cleaner may be connected to another industrial cleaner using some type of fastener, for example, a screw and a bolt. Additionally, where one or more industrial cleaners are used in tandem, the series of industrial cleaners may be powered using a single air supply. As an exemplary embodiment, one industrial cleaner may use a course abrasive media for removing heavy residue from the platen and the following industrial cleaner may use a file for removing defects from the metal platen.

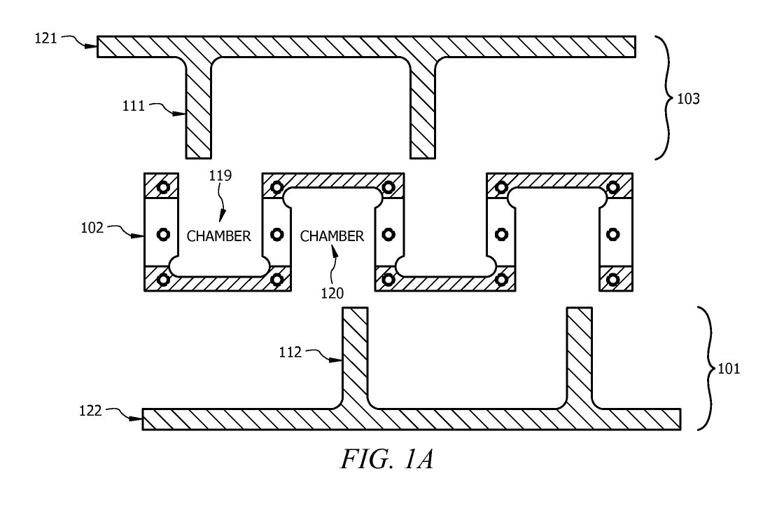

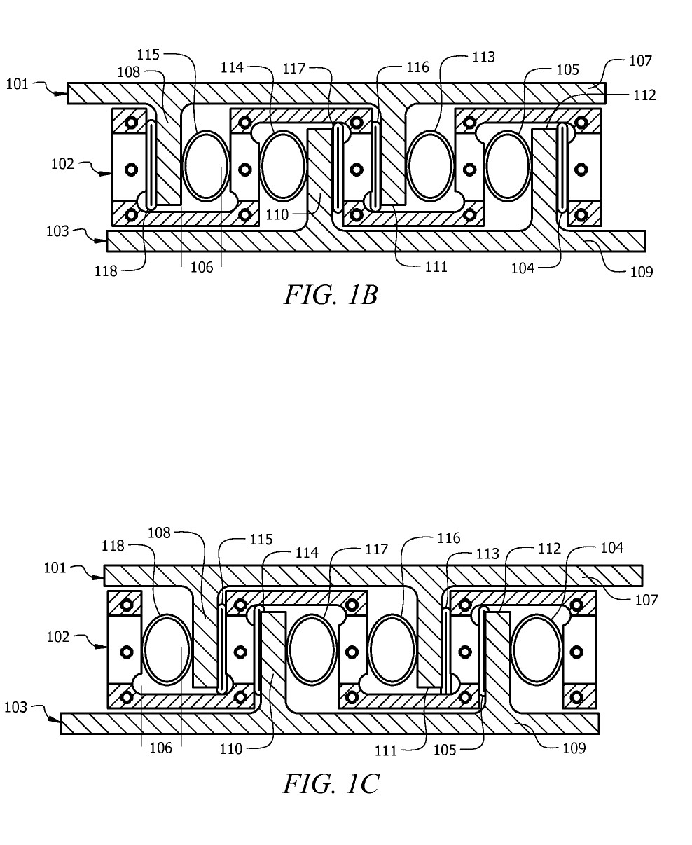

Reference is now made to the figures which are used herein to describe non-limiting exemplary embodiments of the present invention. FIG. 1A shows an simplified view of the linear air motor. The structural elements of the first movable member, 101, include a platform, 121, and at least one member, 111, perpendicular to the platform. The second movable member is structurally similar to the first movable member. The structural elements of the second movable member, 103, include a platform, 122, and at least one member, 112, perpendicular to the platform. As the number of perpendicular members increases, the force exerted by the linear motion of the movable member increases. The first movable member and second movable member are located on opposite sides of the motor housing. The structural elements of the motor housing include at least one set of alternating chambers. The set of two alternating chambers includes one chamber, 119, which receives the perpendicular member of the first movable member, and one chamber, 120, which receives the perpendicular member of the second movable member. In each chamber, the perpendicular member sits between two independently inflated inflatable members. The inflatable members are independently inflated in an alternating manner. This alternating inflation causes the movable member to move back and forth in a longitudinal direction. Preferably, the inflatable members are inflated to cause the first and second movable members to move simultaneously in opposite directions.

FIG. 1B shows a side view of a two-cycle linear motor during the first cycle of motion. In FIG. 1B, the first movable member 101, and the second movable member 103, are separated by the motor housing, 102. As shown in this figure, the motor housing is complimentary to both the first movable member and the second movable member. The first movable member is characterized by major plane 107, and at least one minor plane comprising a member, 108, perpendicular to the major plane. The second movable member is characterized by a major plane, 109 and at least one minor plane 110, comprising a member perpendicular to the major plane. The motor housing is constructed such that an inflatable member may fit into the space on either side of the perpendicular member 111, of the first movable member and either side of the perpendicular member 112 of the second movable member. Inflating the inflatable members 105, 113, 114 and 115, initiates the first cycle of motion for the linear motor. The stroke distance 106 of the first and second movable member during the first cycle is dependent upon the volume capacity and/or the circumference of the inflatable member.

FIG. 1C shows a side view of a two-cycle linear motor during the second cycle of motion. During the second cycle of motion, inflatable members 104, 116, 117 and 118 are inflated and inflatable members 105, 113, 114 and 115 are compressed. As with the first cycle of motion, the stroke distance 107 of the first and second movable members during the second cycle of motion is dependent upon the volume capacity and/or the circumference of the inflatable member.

FIG. 2 shows a rear view of an industrial platen cleaner and provides an example of how two or more industrial press platen cleaners may be used together. FIG. 2 shows an industrial platen cleaner with an abrasive assembly comprising an abrasive media 201, attached to an abrasive assembly platen, 202. As an example, shown in this figure is an adjustable means 203 situated between the first movable platen of a linear motor and the abrasive assembly platen. In this example, the adjustable means is an inflatable member. Any adjustable structure may be used to firmly secure the abrasive assembly against the surface to be cleaned, smoothed and/or polished. For example, a suitable adjustable structure may include, but is not limited to spring, an inflatable member, an adjustable screw, a spongy rubber and/or any combination thereof. Additionally, FIG. 2 shows a first industrial cleaner, 205 connected to a second industrial cleaner, 208. In this example, the first and the second industrial cleaners are connected using a bolt 207. A spacer 206, is used to prevent the movable members of the first and second industrial cleaners from touching.

The stroke direction of the first and second movable plates of the linear motor depends upon the orientation of the motor housing and the combination of inflatable members that are inflated. There are two orientations for the motor housing. In the first orientation, the motor housing has a complimentary section for the perpendicular member of the first movable member that proceeds the first complimentary section for the perpendicular member of the second movable member. In the other orientation, the motor housing has a complimentary section for the perpendicular member of the second movable member that proceeds the first complimentary section for the perpendicular member of the first movable member.

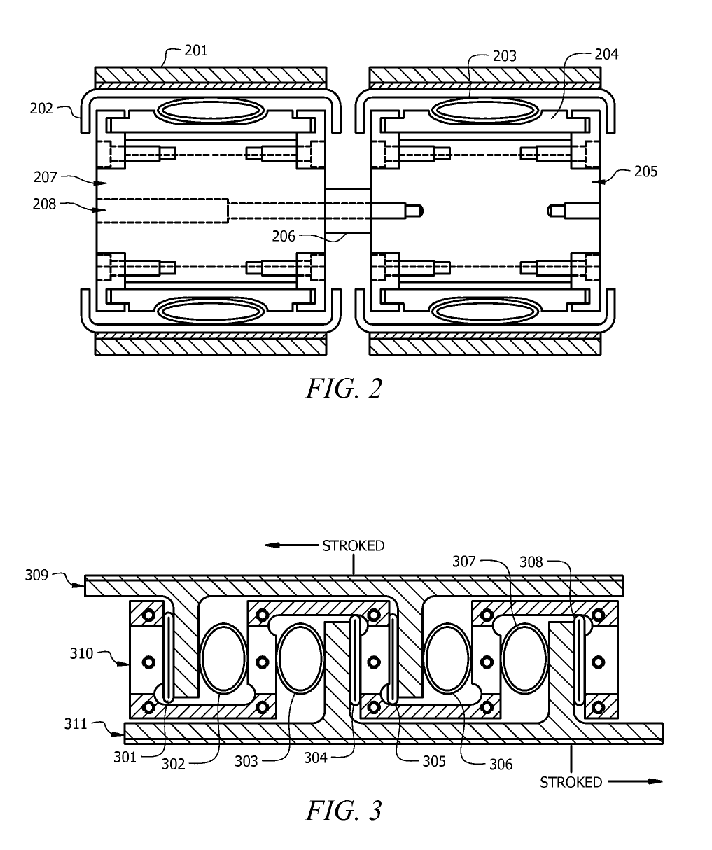

For example, FIG. 3 shows a side view of the linear motor wherein inflatable members 302, 303, 306 and 307 are inflated. The motor housing has a complimentary section for the perpendicular member of the first movable member that proceeds the first complimentary section for the perpendicular member of the second movable member. By inflating inflatable members 302, 303, 306 and 307, the first movable member 309, moves to the left relative to the motor housing 310, and the second movable member, 311 moves to the right relative to the motor housing. Inflatable members 301, 304, 305 and 308 are not inflated.

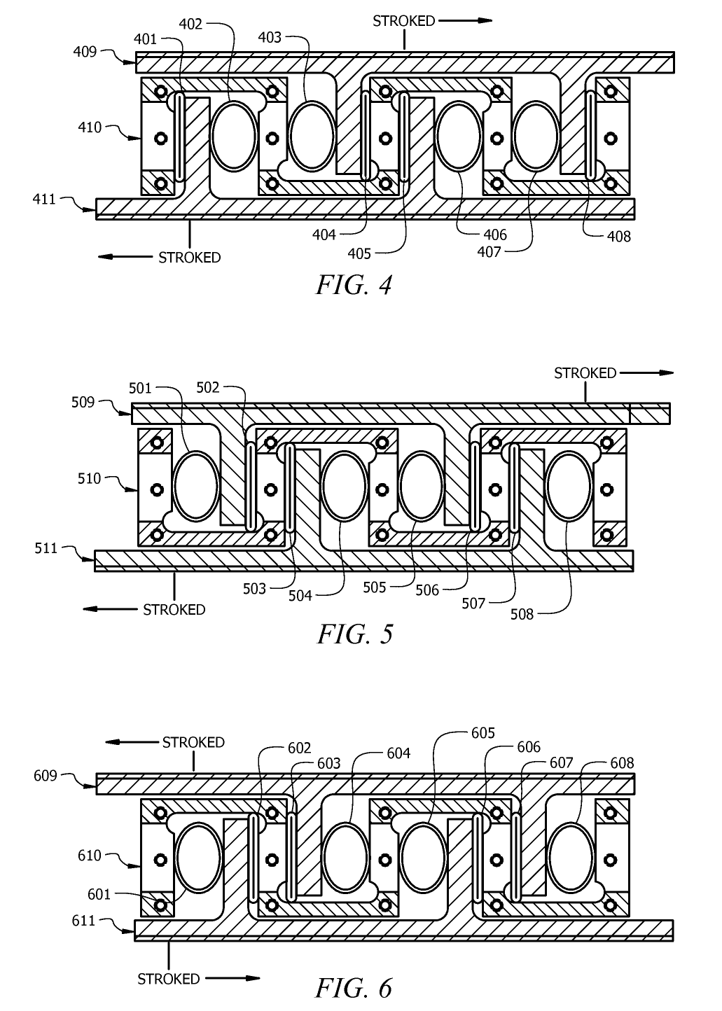

FIG. 4 show a side view of the linear motor wherein the inflatable members 402, 403, 406 and 407 are inflated. The motor housing has a complimentary section for the perpendicular member of the second movable member that proceeds the first complimentary section for the perpendicular member of the first movable member. By inflating inflatable members 402, 403, 406 and 407, the first movable member 409, moves to the right relative to the motor housing, 410, and the second movable member, 411 moves to the left relative to the motor housing. Inflatable members 401, 404, 405, and 408 are not inflated.

FIG. 5 shows a side view of the linear motor wherein inflatable members 501, 504, 505 and 508 are inflated. The motor housing has a complimentary section for the perpendicular member of the first movable member that proceeds the first complimentary section for the perpendicular member of the second movable member. By inflating inflatable members 501, 504, 505 and 508, the first movable member 509, moves to the right relative to the motor housing, 510, and the second movable member, 511 moves to the left relative to the motor housing. Inflatable members 502, 503, 506 and 507 are not inflated.

FIG. 6 shows a side view of the linear motor wherein inflatable members 601, 604, 605 and 608 are inflated. The motor housing has a complimentary section for the perpendicular member of the second movable member that proceeds the first complimentary section for the perpendicular member of the first movable member. By inflating inflatable members 601, 604, 605 and 608, the first movable member 609, moves to the left relative to the motor housing 610 and the second movable member 611 moves to the right relative to the motor housing. Inflatable members 602, 603, 606 and 607 are not inflated.

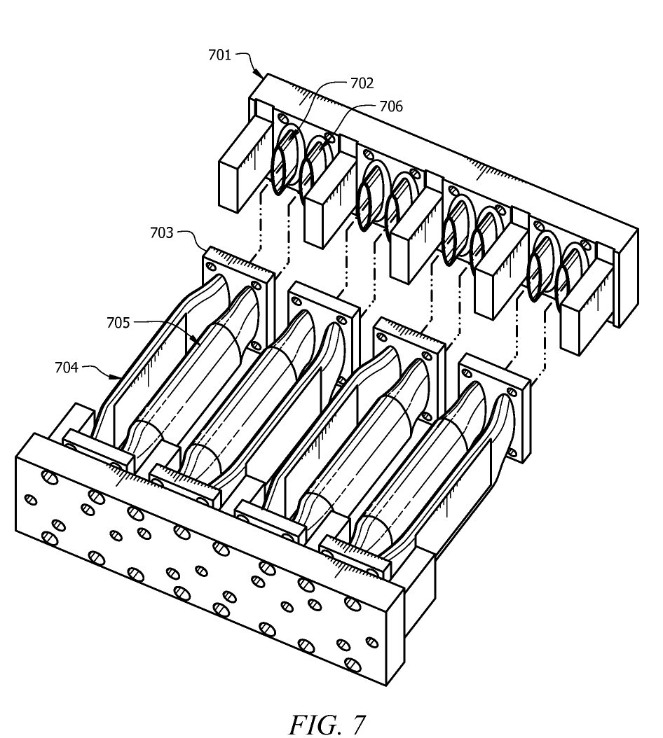

FIG. 7 shows the inflatable members connected to the linear air motor header. The air supply to the inflatable members is supplied through the linear air motor header. This header comprises an alternating actuator valve, a set male headers 702 and 706 connected to the alternating actuator valve. The alternating actuator valve causes air to flow through the set of male headers 702 and 706 in an alternating fashion. For example, when inflatable member 705 is inflated, inflatable member 704 is not inflated. Alternating the air supply causes the linear motion of the first and second movable members. The inflatable members, 704 and 705, are attached to the male headers, 702 and 706, and secured to the headers using a female clamp, 703. The inflatable members are secured at each end to a linear air motor header.

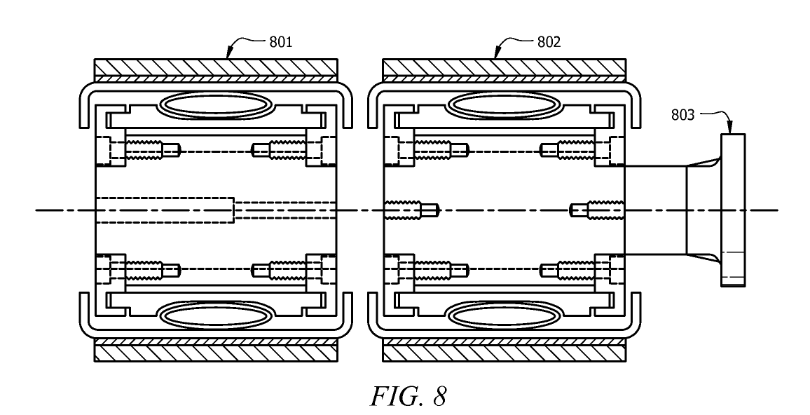

FIG. 8 is a rear view of a industrial platen cleaner and provides an example of how two or more industrial platen cleaners may be powered by one air supply. The first industrial platen cleaner 801 is connected to the second industrial platen cleaner 802 and the linear air motor header, 803 supplies air pressure to 802 and/or 801.

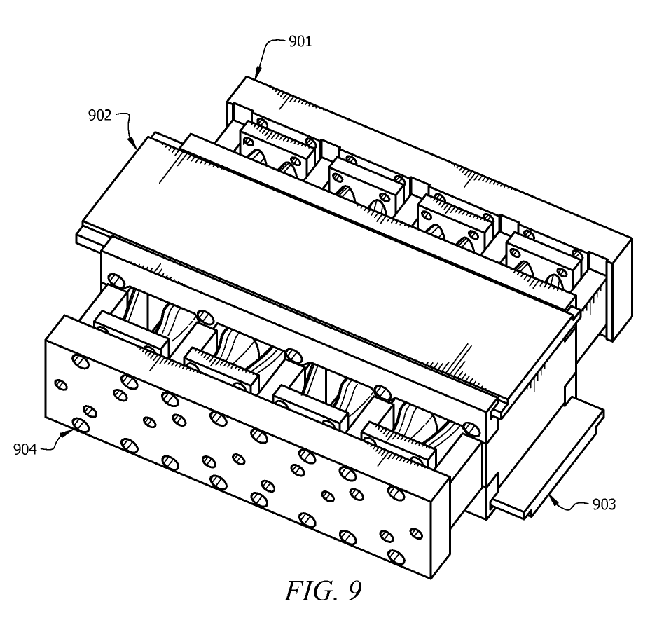

FIG. 9 shows a perspective view of the linear air motor. In this embodiment, two slidable members, 902 and 903, are situated between two linear air motor headers, 901 and 904, and situated on the top and the bottom of the linear air motor. The alternating action of the inflatable members cause the slidable members, 902 and 903 to move in opposite directions in parallel planes.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An apparatus for cleaning the surface of a press platen comprising
a) a linear motor configured to be capable of moving at least one movable member of the apparatus between at least two positions, and
b) at least one abrasive assembly operatively connected to the movable member.

2. The apparatus of claim 1, wherein the apparatus further comprises a first movable member and a second movable member operatively coupled to a linear motor housing and the linear motor housing is configured to be capable of moving the first movable member and the second movable member simultaneously.

3. The apparatus of claim 2, wherein the linear motor housing is configured to move the first movable member the opposite direction and parallel to the simultaneous movement of the second movable member.

4. The apparatus of claim 3, wherein at least one abrasive assembly is secured to the first movable member and/or at least one abrasive assembly is secured to the second movable member.

5. The apparatus of claim 1, wherein the linear motor is a two cycle linear air motor operatively connected to an air supply.

6. The apparatus of claim 1, wherein the apparatus is adapted to fit between two generally parallel platen surfaces such that the abrasive assembly is capable of contacting a first press platen surface sufficiently to be capable of reducing a thickness of a resin layer adhered to the first press platen surface upon operation of the apparatus.

7. The apparatus of claim 6, wherein the apparatus is capable of removing substantially all of the resin layer from the press platen surface.

8. The apparatus of claim 6, wherein the apparatus is further capable of creating a substantially uniform press platen surface.

9. The apparatus of claim 6, wherein the abrasive assembly further comprises an abrasive media selected from the group consisting of: sand paper, scraper blades, file segments, scouring pad, a brush and any combination thereof.

10. The apparatus of claim 5, wherein the two cycle linear air motor comprises
a) a motor housing configured to define at least a first and a second chamber wherein the chambers have at least one opening and wherein the openings of consecutive chambers are positioned approximately 180 degrees from each other,
b) a first movable member comprising a platform and at least one first perpendicular member, wherein the first perpendicular member is received by the first chamber of the motor housing;
c) a second movable member comprising a platform and at least one second perpendicular member, wherein the second perpendicular member is received by the second chamber of the motor housing;
d) at least one set of first inflatable elements wherein the set further comprises two first inflatable elements, and wherein one first inflatable element is positioned in the first chamber and the other inflatable element is positioned in the second chamber;
e) at least one set of second inflatable elements wherein the set further comprises two second inflatable elements, and wherein one second inflatable element is positioned in the first chamber and the other inflatable element is positioned in the second chamber;
wherein the first chamber has a first perpendicular member situated between the first inflatable element and the second inflatable element and the second chamber has a second perpendicular member situated between the first inflatable element and a second inflatable element,
wherein the air supply is operatively connected to the first set of inflatable elements and the second set of inflatable elements.

11. The apparatus of claim 10, wherein the air supply provides air pressure to the first set of inflatable elements and the second set of inflatable elements in an alternating cycle.

12. The apparatus of claim 11, wherein the air pressure provided by the air supply is between 30 psi to 600 psi.

13. The method of cleaning at least a first press platen spaced parallel to a second press platen comprising the steps of:
placing a cleaning apparatus between the first press platen and the second press platen, wherein the cleaning apparatus comprises at least one abrasive assembly and a linear motor;
initializing the linear motor;
moving the cleaning apparatus along a longitudinal path between the first press platen and second press platen, thereby removing residue from at least the first press platen.

14. The method of claim 13, further comprising the step of removing indentations from at least the first press platen.

15. The method of claim 13, further comprising the step of polishing at least the first press platen.

16. The method of claim 13, further comprising the step of smoothing at least the first press platen.
